(19) United States
(12) Patent Application Publication
(10) Pub. No.: US 2007/0212022 A1
(43) Pub. Date: Sep. 13, 2007

(54) Electrophoretic Display with Reduced Cross Talk

(75) Inventors: Guofu Zhou, Best (NL); Jan Van de Kamer, Heerlen (NL); Mark T. Johnson, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/599,256

(22) PCT Filed: Mar. 29, 2005
(86) PCT No.: PCT/IB05/51060

§ 371 Date: Sep. 23, 2006

Related U.S. Application Data
(60) Provisional application No. 60/557,499, filed on Mar. 30, 2004.

(51) Int. Cl. H04N 5/91

(52) U.S. Cl. 386/94; 386/107

(57) ABSTRACT

A technique for driving a bi-stable display (310) such as an electrophoretic display with reduced cross talk, including reduced image retention and dithering ghosting. Drive waveforms are aligned so that, during an image update period, image transitions (500, 600, 700, 800, 900) between substantially similar optical states (e.g., black-to-black) are terminated substantially later than image transitions (520, 620, 720, 920) between substantially different optical states (e.g., black-to-white). Additionally, a drive pulse in the waveforms for the transitions between the similar states compensates for cross talk caused by a drive pulse in the waveforms for the transitions between the different states. The waveforms include at least one extreme drive pulse (ED, ED1, ED2, ED3) and an additional pulse (A) of opposite polarity.

The invention relates generally to electronic reading devices such as electronic books and electronic newspapers and, more particularly, to a method and apparatus for reducing cross talk when updating a bi-stable display.

Recent technological advances have provided “user friendly” electronic reading devices such as e-books that open up many opportunities. For example, electrophoretic displays hold much promise. Such displays have an intrinsic memory behavior and are able to hold an image for a relatively long time without power consumption. Power is consumed only when the display needs to be refreshed or updated with new information. So, the power consumption in such displays is very low, suitable for applications for portable e-reading devices like e-books and e-newspaper. Electrophoresis refers to movement of charged particles in an applied electric field. When electrophoresis occurs in a liquid, the particles move with a velocity determined primarily by the viscous drag experienced by the particles, their charge (either permanent or induced), the dielectric properties of the liquid, and the magnitude of the applied field. An electrophoretic display is a type of bi-stable display, which is a display that substantially holds an image without consuming power after an image update.

For example, international patent application WO 99/53373, published Apr. 9, 1999, by E Ink Corporation, Cambridge, Mass., US, and entitled Full Color Reflective Display With Multichromatic Sub-Pixels, describes such a display device. WO 99/53373 discusses an electronic ink display having two substrates. One is transparent, and the other is provided with electrodes arranged in rows and columns. A display element or pixel is associated with an intersection of a row electrode and column electrode. The display element is coupled to the column electrode using a thin film transistor (TFT), the gate of which is coupled to the row electrode. This arrangement of display elements, TFT transistors, and row and column electrodes together forms an active matrix. Furthermore, the display element comprises a pixel electrode. A row driver selects a row of display elements, and a column or source driver supplies a data signal to the selected row of display elements via the column electrodes and the TFT transistors. The data signals correspond to graphic data to be displayed, such as text or figures.

The electronic ink is provided between the pixel electrode and a common electrode on the transparent substrate. The electronic ink comprises multiple microcapsules of about 10 to 50 microns in diameter. In one approach, each microcapsule has positively charged white particles and negatively charged black particles suspended in a liquid carrier medium or fluid. When a positive voltage is applied to the pixel electrode, the white particles move to a side of the microcapsule directed to the transparent substrate and a viewer will see a white display element. At the same time, the black particles move to the pixel electrode at the opposite side of the microcapsule where they are hidden from the viewer. By applying a negative voltage to the pixel electrode, the black particles move to the common electrode at the side of the microcapsule directed to the transparent substrate and the display element appears dark to the viewer. At the same time, the white particles move to the pixel electrode at the opposite side of the microcapsule where they are hidden from the viewer. When the voltage is removed, the display device remains in the acquired state and thus exhibits a bi-stable character. In another approach, particles are provided in a dyed liquid. For example, black particles may be provided in a white liquid, or white particles may be provided in a black liquid. Or, other colored particles may be provided in different colored liquids, e.g., white particles in blue liquid.

Other fluids such as air may also be used in the medium in which the charged black and white particles move around in an electric field (e.g., Bridgestone SID2003—Symposium on Information Displays. May 18-23, 2003,—digest 20.3). Colored particles may also be used.

To form an electronic display, the electronic ink may be printed onto a sheet of plastic film that is laminated to a layer of circuitry. The circuitry forms a pattern of pixels that can then be controlled by a display driver. Since the microcapsules are suspended in a liquid carrier medium, they can be printed using existing screen-printing processes onto virtually any surface, including glass, plastic, fabric and even paper. Moreover, the use of flexible sheets allows the design of electronic reading devices that approximate the appearance of a conventional book.

However, cross talk, including image retention and dithering ghosting, can occur when updating a bi-stable display such as an electrophoretic display, particularly when pixels that undergo transitions between the same or substantially similar optical states are near pixels that undergo transitions between opposite or substantially different optical states. A technique is thus needed for reducing cross talk.

The invention addresses the above and other issues.

In a particular aspect of the invention, a method for driving a bi-stable display with reduced cross talk comprises: (a) accessing data defining at least first and second voltage waveforms, (b) generating the first voltage waveform for driving a first portion of the bi-stable display according to the accessed data from a first optical state to a second optical state that is close to the first optical state, and (c) generating the second voltage waveform for driving a second portion of the bi-stable display (310) according to the accessed data from the first optical state to a third optical state that is substantially different than the first optical state, such that the second voltage waveform is set to terminate at a different time than the first voltage waveform by a time difference (t2) of at least one frame period (FT). For example, the image transitions may be terminated sooner when there is a transition to a substantially different state.

In another aspect of the invention, at least part of various voltage pulses in one drive waveform applied to a subject pixel are supplied and arranged in such a way that the electric field on the subject pixel induced by the voltage pulse applied on the neighboring pixel is compensated, e.g., prior to the termination of the drive waveform. For example, when a negative voltage pulse is supplied on the neighboring pixel, a compensating positive pulse may be simultaneously supplied on the subject pixel. The compensating pulse may be at least partially overlapping with the pulse causing the cross talk.

A related electronic reading device and program storage device are also provided.

In the drawings:

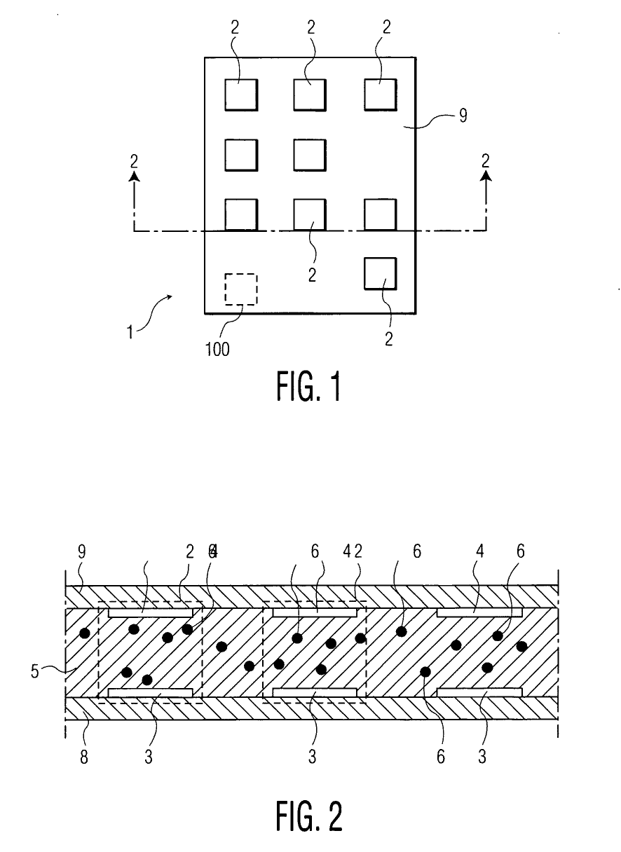

FIG. 1 shows diagramatically a front view of an embodiment of a portion of a display screen of an electronic reading device;

FIG. 2 shows diagramatically a cross-sectional view along 2-2 in FIG. 1;

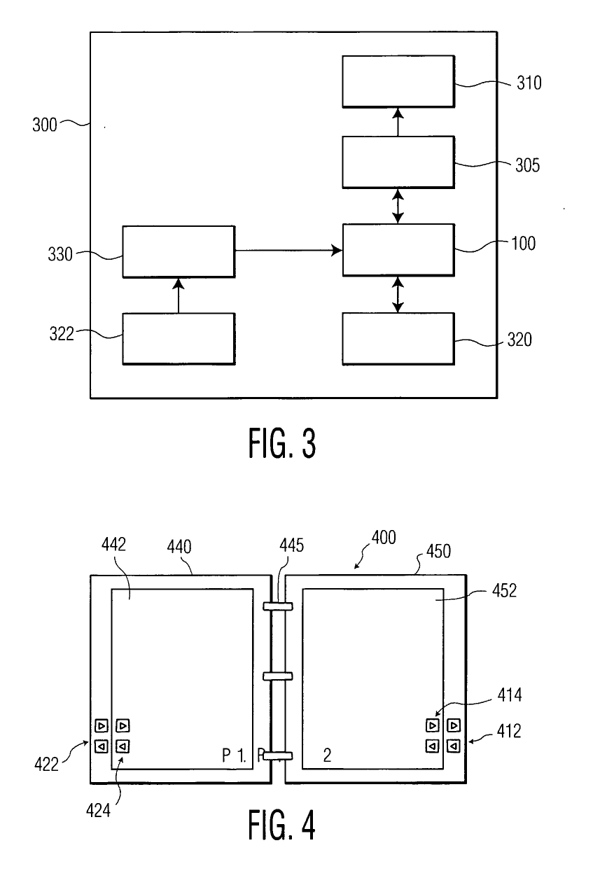

FIG. 3 shows diagramatically an overview of an electronic reading device;

FIG. 4 shows diagramatically two display screens with respective display regions;

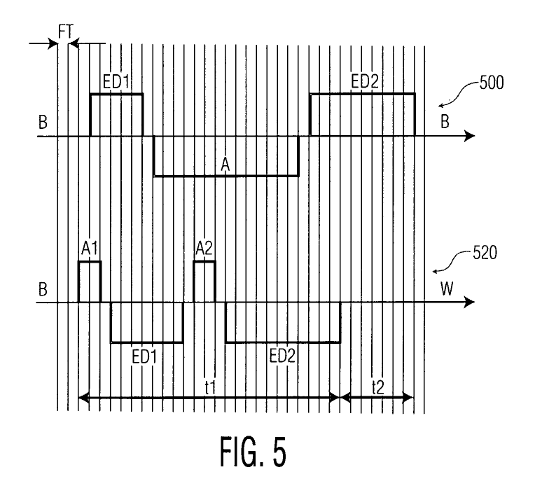

FIG. 5 illustrates a first embodiment of waveforms for updating a bi-stable display;

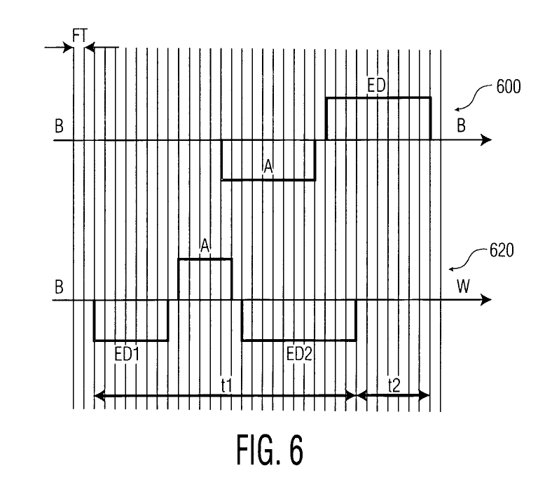

FIG. 6 illustrates a second embodiment of waveforms for updating a bi-stable display;

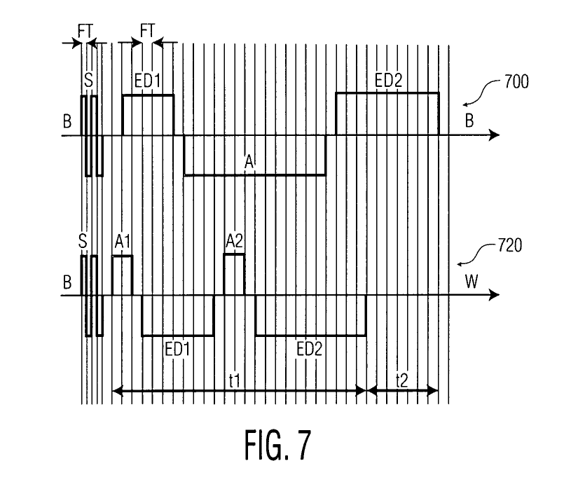

FIG. 7 illustrates a third embodiment of waveforms for updating a bi-stable display;

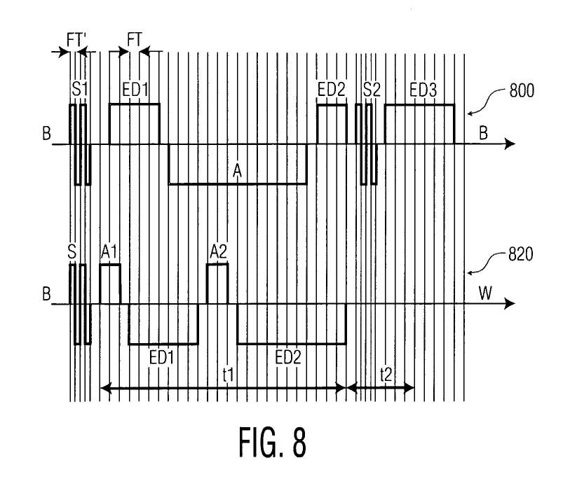

FIG. 8 illustrates a fourth embodiment of waveforms for updating a bi-stable display;

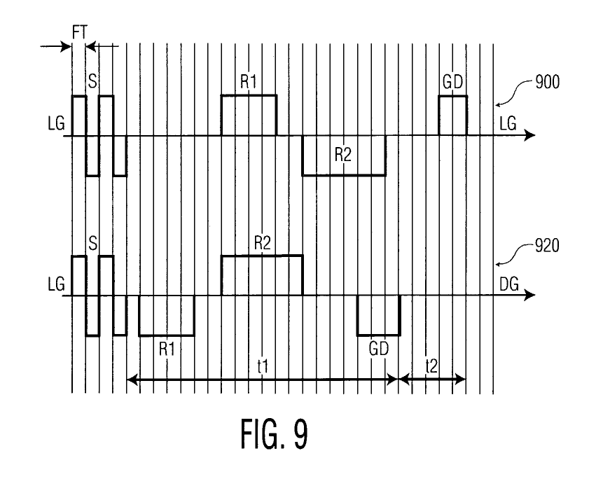

FIG. 9 illustrates a fifth embodiment of waveforms for updating a bi-stable display; and

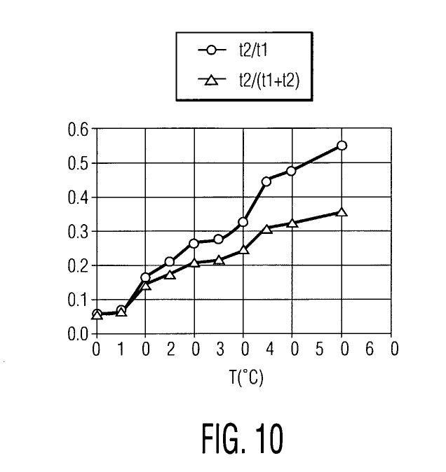

FIG. 10 illustrates a temperature dependence of the termination time difference between the two drive waveforms of FIG. 5.

In all the Figures, corresponding parts are referenced by the same reference numerals.

Each of the following is incorporated herein by reference:

European patent application EP 02078823.8, entitled “Electrophoretic Display Panel”, filed Sep. 16, 2002 (docket no. PHNL 020844);

European patent application EP 03100133.2, entitled “Electrophoretic display panel”, filed Jan. 23, 2003 (docket no. PHNL 030091);

European patent application EP 02077017.8, entitled “Display Device”, filed May 24, 2002, or WO 03/079323, Electrophoretic Active Matrix Display Device”, published Feb. 6, 2003 (docket no. PHNL 020441); and

European patent application EP 03101705.6, entitled “Electrophoretic Display Unit”, filed Jun. 11, 2003 (docket no. PHNL 030661).

FIGS. 1 and 2 show the embodiment of a portion of a display panel 1 of an electronic reading device having a first substrate 8, a second opposed substrate 9 and a plurality of picture elements 2. The picture elements 2 may be arranged along substantially straight lines in a two-dimensional structure. The picture elements 2 are shown spaced apart from one another for clarity, but in practice, the picture elements 2 are very close to one another so as to form a continuous image. Moreover, only a portion of a full display screen is shown. Other arrangements of the picture elements are possible, such as a honeycomb arrangement. An electrophoretic medium 5 having charged particles 6 is present between the substrates 8 and 9. A first electrode 3 and second electrode 4 are associated with each picture element 2. The electrodes 3 and 4 are able to receive a potential difference. In FIG. 2, for each picture element 2, the first substrate has a first electrode 3 and the second substrate 9 has a second electrode 4. The charged particles 6 are able to occupy positions near either of the electrodes 3 and 4 or intermediate to them.

Each picture element 2 has an appearance determined by the position of the charged particles 6 between the electrodes 3 and 4. Electrophoretic media 5 are known per se, e.g., from U.S. Pat. Nos. 5,961,804, 6,120,839, and 6,130,774 and can be obtained, for instance, from E Ink Corporation.

As an example, the electrophoretic medium 5 may contain negatively charged black particles 6 in a white fluid. When the charged particles 6 are near the first electrode 3 due to a potential difference of, e.g., +15 Volts, the appearance of the picture elements 2 is white. When the charged particles 6 are near the second electrode 4 due to a potential difference of opposite polarity, e.g., −15 Volts, the appearance of the picture elements 2 is black. When the charged particles 6 are between the electrodes 3 and 4, the picture element has an intermediate appearance such as a grey level between black and white. An application-specific integrated circuit (ASIC) 100 controls the potential difference of each picture element 2 to create a desired picture, e.g. images and/or text, in a full display screen. The full display screen is made up of numerous picture elements that correspond to pixels in a display.

FIG. 3 shows diagramatically an overview of an electronic reading device. The electronic reading device 300 includes the display ASIC 100. For example, the ASIC 100 may be the Philips Corp. “Apollo” ASIC E-ink display controller. The display ASIC 100 controls the one or more display screens 310, such as electrophoretic screens, via an addressing circuit 305, to cause desired text or images to be displayed. The addressing circuit 305 includes driving integrated circuits (ICs). For example, the display ASIC 100 may act as a voltage source that provides voltage waveforms, via an addressing circuit 305, to the different pixels in the display screen 310. The addressing circuit 305 provides information for addressing specific pixels, such as row and column, to cause the desired image or text to be displayed. The display ASIC 100 causes successive pages to be displayed starting on different rows and/or columns. The image or text data may be stored in a memory 320, which represents one or more storage devices, and accessed by the ASIC 100 as needed. One example is the Philips Electronics small form factor optical (SFFO) disk system, in other systems a non-volatile flash memory could be utilized. The electronic reading device 300 further includes a reading device controller 330 or host controller, which may be responsive to a user-activated software or hardware button 322 that initiates a user command such as a next page command or previous page command.

The reading device controller 330 may be part of a computer that executes any type of computer code devices, such as software, firmware, micro code or the like, to achieve the functionality described herein. Accordingly, a computer program product comprising such computer code devices may be provided in a manner apparent to those skilled in the art. The reading device controller 330 may further comprise a memory (not shown) that is a program storage device that tangibly embodies a program of instructions executable by a machine such as the reading device controller 330 or a computer to perform a method that achieves the functionality described herein. Such a program storage device may be provided in a manner apparent to those skilled in the art.

The display ASIC 100 may have logic for periodically providing a forced reset of a display region of an electronic book, e.g., after every x pages are displayed, after every y minutes, e.g., ten minutes, when the electronic reading device 300 is first turned on, and/or when the brightness deviation is larger than a value such as 3% reflection. For automatic resets, an acceptable frequency can be determined empirically based on the lowest frequency that results in acceptable image quality. Also, the reset can be initiated manually by the user via a function button or other interface device, e.g., when the user starts to read the electronic reading device, or when the image quality drops to an unacceptable level.

The ASIC 100 provides instructions to the display addressing circuit 305 for driving the display 310 by accessing information stored in the memory 320.

The invention may be used with any type of electronic reading device. FIG. 4 illustrates one possible example of an electronic reading device 400 having two separate display screens. Specifically, a first display region 442 is provided on a first screen 440, and a second display region 452 is provided on a second screen 450. The screens 440 and 450 may be connected by a binding 445 that allows the screens to be folded flat against each other, or opened up and laid flat on a surface. This arrangement is desirable since it closely replicates the experience of reading a conventional book.

Various user interface devices may be provided to allow the user to initiate page forward, page backward commands and the like. For example, the first region 442 may include on-screen buttons 424 that can be activated using a mouse or other pointing device, a touch activation, PDA pen, or other known technique, to navigate among the pages of the electronic reading device. In addition to page forward and page backward commands, a capability may be provided to scroll up or down in the same page. Hardware buttons 422 may be provided alternatively, or additionally, to allow the user to provide page forward and page backward commands. The second region 452 may also include on-screen buttons 414 and/or hardware buttons 412. Note that the frame around the first and second display regions 442, 452 is not required as the display regions may be frameless. Other interfaces, such as a voice command interface, may be used as well. Note that the buttons 412, 414; 422, 424 are not required for both display regions. That is, a single set of page forward and page backward buttons may be provided. Or, a single button or other device, such as a rocker switch, may be actuated to provide both page forward and page backward commands. A function button or other interface device can also be provided to allow the user to manually initiate a reset.

In other possible designs, an electronic book has a single display screen with a single display region that displays one page at a time. Or, a single display screen may be partitioned into or two or more display regions arranged, e.g., horizontally or vertically. Furthermore, when multiple display regions are used, successive pages can be displayed in any desired order. For example, in FIG. 4, a first page can be displayed on the display region 442, while a second page is displayed on the display region 452. When the user requests to view the next page, a third page may be displayed in the first display region 442 in place of the first page while the second page remains displayed in the second display region 452. Similarly, a fourth page may be displayed in the second display region 452, and so forth. In another approach, when the user requests to view the next page, both display regions are updated so that the third page is displayed in the first display region 442 in place of the first page, and the fourth page is displayed in the second display region 452 in place of the second page. When a single display region is used, a first page may be displayed, then a second page overwrites the first page, and so forth, when the user enters a next page command. The process can work in reverse for page back commands. Moreover, the process is equally applicable to languages in which text is read from right to left, such as Hebrew, as well as to languages such as Chinese in which text is read column-wise rather than row-wise.

Additionally, note that the entire page need not be displayed on the display region. A portion of the page may be displayed and a scrolling capability provided to allow the user to scroll up, down, left or right to read other portions of the page. A magnification and reduction capability may be provided to allow the user to change the size of the text or images. This may be desirable for users with reduced vision, for example.

Problem Addressed

In order to increase the response speed of a bi-stable display such as an electrophoretic display and reduce optical flicker, it is desirable to resistively drive the display. In displays based upon electrophoretic particles in films comprising capsules (E-Ink Corp.) or micro-cups (SiPix Group), adhesive layers and binder layers are required for the construction. To achieve a resistive driving mode and increase the response speed, it is therefore necessary to reduce the conductivity of these components. However, this unavoidably leads to lateral cross talk, where a portion of the electric field associated with one pixel is inadvertently spread to a neighboring pixel, causing the neighboring pixel to become partially switched to the wrong color, e.g., grey level. The neighboring pixel can be an adjacent pixel or other pixel that is sufficiently close to experience cross talk. This is quite visible where a pixel driven to an extreme optical state, e.g., black or white, is situated adjacent to a pixel that is gently driven or not driven at all. This situation is frequently encountered where additional grey levels are achieved using spatial dithering techniques.

For example, consider a portion of a screen that switches from a black and white block image to a checkerboard-like, spatially dithered, mid-grey pattern, with each adjacent pixel being either black or white. In the black region, those pixels that must become white are driven with a negative voltage, while those that should remain black are not driven. However, due to the cross talk effect, a portion of the drive voltage is transferred to these black pixels, which are inadvertently driven toward white, becoming a grey color at the end of the image update. Consequently, the central portion of the checkerboard pattern becomes too light in color. In contrast, in the white region, those pixels that must become black are driven with a positive voltage, while those that should remain white are not driven. However, due to the cross talk effect, a portion of the drive voltage is transferred to these white pixels, which are inadvertently driven toward black, becoming a grey color at the end of the image update. Consequently, the outer portion of the checkerboard pattern becomes too dark in color.

Proposed Solution

In accordance with the invention, a technique is provided for driving a bi-stable display such as an electrophoretic display with reduced cross talk, including reduced color or grey level error, image retention and dithering ghosting. To achieve this, in one aspect of the invention, at least part of various voltage pulses in one drive waveform applied to a pixel are supplied and arranged in such a way that the electric field on a pixel induced by the voltage pulse applied on the neighboring pixel is immediately compensated. For example, when a negative voltage pulse is supplied on the neighboring pixel of a subject pixel, a positive pulse is simultaneously supplied on the subject pixel. In another aspect of the invention, the drive waveforms are aligned in such a way that, during an image update period, the image transitions from a given optical state to a substantially similar or otherwise close optical state (e.g., black-to-black, white-to-white or black-to-dark gray) are terminated at different times than for transitions from the same initial optical state to a substantially different state (e.g., black-to-white or white-to-black). The optical states that are close to one another include states that are the same as well as states that vary by one or a small number of greyscale or color levels. For example, with four greyscale levels, states that differ by one greyscale level are relatively close to one another. Examples include black and dark grey, dark grey and light grey, and light grey and white. With sixteen greyscale levels, states that differ by, e.g., up to three greyscale levels, may be considered close. In another approach, states that differ by a certain fraction of the greyscale, such as one fourth, e.g., four levels out of sixteen, may be considered close.

In a further aspect of the invention, the drive waveforms are terminated later for transitions between the substantially similar or otherwise close states than for transitions between substantially different states. A dithering pattern may be created by the transition to the substantially different state together with the corrected initial state.

The drive waveforms, in particular those applied for updating pixels without a substantial optical state change, include at least two voltage pulses with opposite polarity, where the last voltage pulse brings the particles toward the desired final optical state. FIG. 5 illustrates the first embodiment of the invention for image transitions from black (B)-to-black (B), in waveform 500, and black (B)-to-white (W), in waveform 520. With waveform 520, both the initial and final optical states are extreme or rail optical states, e.g., black or white. Each waveform includes at least two voltage pulses: additional pulses (A, A1, A2) and extreme drive pulses (ED1, ED2). Generally, the polarity of the additional pulses (A, A1, A2) is opposite to that of the drive pulses (ED1, ED2). Moreover, the polarities of multiple extreme drive pulses (ED1, ED2) in the same waveform are usually the same. Similarly, the polarities of multiple additional pulses (A1, A2) in the same waveform are usually the same.

In the waveform diagrams discussed herein, the vertical lines represent frame boundaries and the horizontal axis represents time. The vertical axis represents a voltage.

For example, pulse width modulation (PWM) may be used with voltages of −15 V, 0 V and +15 V. A frame time or period is indicated as FT. Extreme drive pulses refer to drive pulses in a drive waveform that bring the particles to one of the two extreme positions near one of the two electrodes.

In waveform 520, four voltage pulses are used. The first extreme drive (ED1) pulse and the second extreme drive (ED2) pulse drive the display to the desired white state. The additional pulses (A1, A2) are used for increasing the white state stability and reducing the residual voltage on the pixel in the transition. In waveform 500, triple pulses are used, where the first positive extreme drive pulse (ED1) acts to pin or reinforce the black state, e.g., by ensuring the pixel does not drift away from the pure black state, and reduce residual voltage. An additional negative pulse (A) brings the particles away from the electrode, and the second extreme drive pulse (ED2) sends or drives the particles back close to the electrode, i.e., to the desired final black state.

The duration/energy of the first extreme drive pulse (ED1) in waveform 500 is determined by the amount of residual voltage involved in voltage pulses A and ED2, i.e., the sum of the energy involved in A and ED2 pulses, and the pulse configuration of the drive waveform on the neighboring pixel when, for example, applying waveform 520 for a black to white transition. The timing/position of this extreme drive pulse is also determined by the pulse configuration of the drive waveform on the neighboring pixel. For example, in waveform 520, a positive pulse (A1) with duration of two FTs is followed by a negative pulse (ED1) with duration of seven frames, after which a two-frame positive pulse (A2) is applied, followed by a negative pulse (ED2) with duration of eleven frames. When waveform 520 is applied to drive a first pixel, or group of pixels, from B to W, where the first pixel is a neighboring pixel of a second, black pixel that is driven by the waveform 500, the second black pixel will receive portions of the electric field from the waveform 520 as a result of cross talk. The cross talk effect of the first positive pulse (A1) in 520 does not change the optical state of the neighboring first pixel because the second pixel is in the black state. However, the second negative pulse (ED1) in 520 induces a brightness drift on the second pixel toward dark grey.

To avoid this brightness drift, a positive pulse (ED1, waveform 500) is applied on the second pixel to compensate for the cross talk effect from the negative pulse (ED1) in the waveform 520. The positive pulse may be at least partially concurrent, e.g., overlapping, with the negative pulse. After completion of this positive pulse in waveform 500, a larger negative pulse (A) is applied on the black pixel, followed by a positive pulse (ED2) to achieve the desired final brightness and brightness decay curve after addressing. Moreover, the drive waveform 500 for the black-to-black transition is terminated at a different time than for the black-to-white transition, as indicated by the time difference t2, to completely compensate the cross talk. In this example, the drive waveform (500) is terminated substantially later than for the drive waveform (520).

The time period difference (t2) between the termination times of the waveforms 500, 520 is at least one frame time (FT). t1 denotes the duration of the earlier-ending waveform, e.g., waveform 520. t2/(t1+t2)×100% may be larger than about 5-15%, for instance, depending on the ambient temperature. Refer to FIG. 10 for further information.

In the above example, a pulse-width modulated (PWM) driving scheme is used. In case other driving schemes, e.g., using voltage modulated (VM) or combined VM and PWM are used, the energy involved in the various pulses may be used in place of pulse duration. The energy of a voltage pulse is the product of the voltage amplitude (V) and time duration (t): i.e., t*V.

The second embodiment of the invention is illustrated in FIG. 6, in which the waveforms are constructed based on the first embodiment, but the total image update time is shortened. In particular, drive waveform 600 uses an additional pulse (A) with a reduced duration, and only one ED pulse is applied. Waveform 600 denotes the black-to-black transition, and includes an extreme drive pulse (ED) and an additional pulse (A). Waveform 620 denotes the black-to-white transition, and includes first and second extreme drive pulses (ED1, ED2) as well as an additional pulse (A). Again, the time period difference for the termination of both transitions is at least one frame time duration, and t2/(t1+t2)×100% may be larger than about 5-15%, for instance, depending on the ambient temperature.

The third embodiment of the invention is illustrated in FIG. 7, which is derived from the first embodiment, but in all drive waveforms a set of shaking pulses (S) is applied prior to the application of the data signal. In particular, waveform 700 for the black-to-black transition includes shaking pulses (S), first and second extreme drive pulses (ED1, ED2) and an additional pulse (A). Waveform 720 for the black-to-white transition includes shaking pulses (S), first and second extreme drive pulses (ED1, ED2), and first and second additional pulses (A1, A2).

A shaking pulse is defined as a voltage pulse representing energy sufficient for releasing particles at their present position but insufficient for moving the particles from their present position to one of the extreme positions. In this example, the shortened frame time (FT′) of these shaking pulses is shorter than the frame time (FT) used for other portions of the waveform, to reduce the flicker induced by shaking pulses. Shaking pulses are discussed in the above-mentioned European patent application EP 02077017.8 (docket no. PHNL 020441). The use of shaking pulses results in a more accurate greyscale because the dwell time and image history effects can be reduced. Again, the time period difference for the termination of both transitions is at least one frame time duration, and t2/(t1+t2)×100% may be larger than about 5-15%, for instance, depending on the ambient temperature.

The fourth embodiment of the invention is illustrated in FIG. 8, which is derived from the third embodiment, but in the drive waveform 800 for the black-to-black transition, a second set of shaking pulses (S2) is applied during a second extreme drive pulse, which is split into two pulses (ED2, ED3). The second set of shaking pulses (S2) further improves the black image quality. In particular, waveform 800 for the black-to-black transition includes first and second shaking pulses (S1, S2), first, second and third extreme drive pulses (ED1, ED2, ED3) and an additional pulse (A). Waveform 720 for the black-to-white transition is the same as in FIG. 7. Also, the frame time (FT′) of these shaking pulses is shorter than the frame time (FT) used for other portions of the waveform, to reduce the flicker induced by the shaking pulses. The shaking pulses may also be applied at other portions of the drive waveform, for example, prior to the extreme drive pulse (ED2). Again, the time period difference for the termination of both transitions is at least one frame time duration, and t2/(t1+t2)×100% may be larger than about 5-15%, for instance, depending on the ambient temperature.

FIG. 9 illustrates the fifth embodiment of the invention for image transitions from light grey (LG)-to-light grey (LG) and light grey (LG)-to-dark grey (DG). In this case, both the initial and final optical states are intermediate optical states, e.g., states between the extreme states of black and white. Similar to the above discussion, the drive waveform for light grey-to-dark grey transition is terminated substantially earlier than that for light grey-to-light grey transition. Note that t2 denotes a time difference that can vary in the different embodiments. Each waveform includes three voltage pulses of different polarity, namely first and second reset pulses (R1, R2), and a greyscale drive pulse (GD). The time period difference (t2) for the termination of both transitions is at least one frame time duration. t2/(t1+t2)×100% may be larger than about 1-5%, for instance, depending on the ambient temperature. So, it is less critical than when two extreme states are dithered.

FIG. 10 illustrates the temperature dependence of the termination time difference, expressed in an energy ratio (t2/t1 and t2/(t1+t2) between the two drive waveforms of FIG. 5. Temperature (T) in degrees C. is shown on the horizontal axis, while an energy ratio is shown on the vertical axis. The plot indicates that the termination time difference increases with increasing temperature. This is because the conductivity of the multiple layers, e.g., adhesive layer, in an electrophoretic display medium increases with increasing temperature, resulting in larger lateral cross talk. Note that when PWM is used, the energy ratio is the same as a time duration ratio since the energy of a pulse is related to the duration of the pulse by a constant voltage amplitude. In this case, the vertical axis also indicates a time ratio. For example, at a temperature of 20 degrees C., t2/t1=0.27, and t2/(t1+t2)=0.20. The energy of a voltage pulse is the product of the voltage amplitude (V) and time duration (t): i.e. t*V.

General Remarks

The invention is applicable to any image transition to correct the brightness of a pixel affected by cross talk from a neighbouring pixel. In particular, the drive waveforms for the image transitions between substantially similar or otherwise close optical states are terminated at a substantially different time, e.g., later, than drive waveforms for image transitions between substantially different states, which are used to create a spatial dithering pattern. It is not necessary to adjust the termination of the other transitions in this manner. Moreover, shaking pulses are optional. A set of shaking pulses can be used anywhere during a drive waveform, and a set of shaking pulses may include one or more shaking pulses.

Note also that, in the above examples, pulse-width modulated (PWM) driving is used for illustrating the invention, where the pulse time is varied in each waveform while the voltage amplitude is kept constant. However, the invention is also applicable to other driving schemes, e.g., based on voltage modulated driving (VM), where the pulse voltage amplitude is varied in each waveform, or combined PWM and VM driving. The invention is applicable to color as well as greyscale bi-stable displays. Also, the electrode structure is not limited. For example, a top/bottom electrode structure, honeycomb structure, an in-plane switching structure or other combined in-plane-switching and vertical switching may be used. Moreover, the invention may be implemented in passive matrix as well as active matrix electrophoretic displays. In fact, the invention can be implemented in any bi-stable display that does not consume power while the image substantially remains on the display after an image update. Also, the invention is applicable to both single and multiple window displays, where, for example, a typewriter mode exists.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for driving a bi-stable display with reduced cross talk, the method comprising:
accessing data defining at least first and second voltage waveforms;
generating the first voltage waveform (500, 600, 700, 800, 900) for driving a first portion of the bi-stable display (310) according to the accessed data from a first optical state to a second optical state that is close to the first optical state; and
generating the second voltage waveform (520, 620, 720, 920) for driving a second portion of the bi-stable display (310) according to the accessed data from the first optical state to a third optical state that is substantially different than the first optical state, such that the second voltage waveform is set to terminate at a different time than the first voltage waveform by a time difference (t2) of at least one frame period (FT).

2. The method of claim 1, wherein:
the generating the second voltage waveform for driving the second portion of the bi-stable display (310) according to the accessed data from the first optical state to the third optical state comprises driving the second portion of the bi-stable display (310) with at least one drive pulse (ED1, ED2); and
the generating the first voltage waveform for driving the first portion of the bi-stable display (310) according to the accessed data from the first optical state to the second optical state comprises driving the first portion of the bi-stable display (310) with at least one drive pulse (ED, ED1, ED2, ED3) that at least partly compensates for a cross talk induced by the at least one drive pulse of the second voltage waveform.

3. The method of claim 2, wherein:
the generating the first voltage waveform for driving the first portion of the bi-stable display (310) according to the accessed data from the first optical state to the second optical state comprises driving the first portion of the bi-stable display (310) so that the at least one drive pulse thereof is at least partly overlapping with the at least one drive pulse of the second voltage waveform.

4. The method of claim 1, wherein:
the generating the second voltage waveform for driving the second portion of the bi-stable display (310) according to the accessed data from the first optical state to the third optical state comprises driving the second portion of the bi-stable display (310) according to the accessed data such that the second voltage waveform is set to terminate before the first voltage waveform by the time difference (t2) of at least one frame period (FT).

5. The method of claim 1, wherein:
the second optical state is substantially the same as the first optical state.

6. The method of claim 1, further comprising:
determining the time difference (t2) based on an ambient temperature (T).

7. The method of claim 1, wherein:
the time difference (t2) relative to a total time (t1) of the second voltage waveform is expressed by t2/(t1+t2)×100%>5%.

8. The method of claim 1, wherein:
the time difference (t2) relative to a total time (t1) of the second voltage waveform is expressed by t2/(t1+t2)×100%>10%.

9. The method of claim 1, wherein:
the generating the second voltage waveform for driving the second portion of the bi-stable display (310) according to the accessed data from the first optical state to the third optical state comprises driving the second portion of the bi-stable display (310) according to the accessed data from one extreme optical state (B, W) to another extreme optical state (W, B).

10. The method of claim 1, wherein:
the generating the second voltage waveform for driving the second portion of the bi-stable display (310) according to the accessed data from the first optical state to the third optical state comprises driving the second portion of the bi-stable display (310) according to the accessed data from one intermediate optical state (LG, DG) to another intermediate optical state (LG, DG).

11. The method of claim 1, wherein:
the generating the second voltage waveform for driving the second portion of the bi-stable display (310) according to the accessed data from the first optical state to the third optical state comprises driving the second portion of the bi-stable display (310) according to the accessed data from one extreme optical state (B, W) to an intermediate optical state (LG, DG).

12. The method of claim 1, wherein:
the generating the second voltage waveform for driving the second portion of the bi-stable display (310) according to the accessed data from the first optical state to the third optical state comprises driving the second portion of the bi-stable display (310) according to the accessed data from one intermediate optical state (LG, DG) to an extreme optical state (B, W).

13. The method of claim 1, wherein:
the generating the first voltage waveform comprises generating the first voltage waveform having at least one driving pulse (ED1, ED2) and at least one additional pulse (A, A1, A2) of opposite polarity; and
the generating the second voltage waveform comprises generating the second voltage waveform having at least one driving pulse (ED, ED1, ED2, ED3) and at least one additional pulse (A, A1, A2) of opposite polarity.

14. The method of claim 1, wherein:
the bi-stable display comprises an electrophoretic display.

15. A program storage device tangibly embodying a program of instructions executable by a machine to perform a method for driving a bi-stable display with reduced cross talk, the method comprising:
accessing data defining at least first and second voltage waveforms;
generating the first voltage waveform (500, 600, 700, 800, 900) for driving a first portion of the bi-stable display (310) according to the accessed data from a first optical state to a second optical state that is close to the first optical state; and
generating the second voltage waveform (520, 620, 720, 920) for driving a second portion of the bi-stable display (310) according to the accessed data from the first optical state to a third optical state that is substantially different than the first optical state, such that the second voltage waveform is set to terminate at a different time than the first voltage waveform by a time difference (t2) of at least one frame period (FT).

16. The program storage device of claim 15, wherein:
the generating the second voltage waveform for driving the second portion of the bi-stable display (310) according to the accessed data from the first optical state to the third optical state comprises driving the second portion of the bi-stable display (310) with at least one drive pulse (ED1, ED2); and
the generating the first voltage waveform for driving the first portion of the bi-stable display (310) according to the accessed data from the first optical state to the second optical state comprises driving the first portion of the bi-stable display (310) with at least one drive pulse (ED, ED1, ED2, ED3) that at least partly compensates for a cross talk induced by the at least one drive pulse of the second voltage waveform.

17. The program storage device of claim 16, wherein:
the generating the first voltage waveform for driving the first portion of the bi-stable display (310) according to the accessed data from the first optical state to the second optical state comprises driving the first portion of the bi-stable display (310) so that the at least one drive pulse thereof is at least partly overlapping with the at least one drive pulse of the second voltage waveform.

18. The program storage device of claim 15, wherein:
the generating the second voltage waveform for driving the second portion of the bi-stable display (310) according to the accessed data from the first optical state to the third optical state comprises driving the second portion of the bi-stable display (310) according to the accessed data such that the second voltage waveform is set to terminate before the first voltage waveform by the time difference (t2) of at least one frame period (FT).

19. The program storage device of claim 15, wherein:
the second optical state is substantially the same as the first optical state.

20. The program storage device of claim 15, wherein the method further comprises:
determining the time difference (t2) based on an ambient temperature (T).

21. The program storage device of claim 15, wherein:
the generating the second voltage waveform for driving the second portion of the bi-stable display (310) according to the accessed data from the first optical state to the third optical state comprises driving the second portion of the bi-stable display (310) according to the accessed data from one extreme optical state (B, W) to another extreme optical state (W, B).

22. The program storage device of claim 15, wherein:
the bi-stable display comprises an electrophoretic display.

23. An electronic reading device, comprising:
a bi-stable display (310); and
a control (100) for driving a bi-stable display with reduced cross talk by: (a) accessing data defining at least first and second voltage waveforms, (b) generating the first voltage waveform (500, 600, 700, 800, 900) for driving a first portion of the bi-stable display (310) according to the accessed data from a first optical state to a second optical state that is close to the first optical state, and (c) generating the second voltage waveform (520, 620, 720, 920) for driving a second portion of the bi-stable display (310) according to the accessed data from the first optical state to a third optical state that is substantially different than the first optical state, such that the second voltage waveform is set to terminate at a different time than the first voltage waveform by a time difference (t2) of at least one frame period (FT).

24. The electronic reading device of claim 23, wherein:
the generating the second voltage waveform for driving the second portion of the bi-stable display (310) according to the accessed data from the first optical state to the third optical state comprises driving the second portion of the bi-stable display (310) with at least one drive pulse (ED1, ED2); and
the generating the first voltage waveform for driving the first portion of the bi-stable display (310) according to the accessed data from the first optical state to the second optical state comprises driving the first portion of the bi-stable display (310) with at least one drive pulse (ED, ED1, ED2, ED3) that at least partly compensates for a cross talk induced by the at least one drive pulse of the second voltage waveform.

25. The electronic reading device of claim 24, wherein:
the generating the first voltage waveform for driving the first portion of the bi-stable display (310) according to the accessed data from the first optical state to the second optical state comprises driving the first portion of the bi-stable display (310) so that the at least one drive pulse thereof is at least partly overlapping with the at least one drive pulse of the second voltage waveform.

26. The electronic reading device of claim 23, wherein:
the generating the second voltage waveform for driving the second portion of the bi-stable display (310) according to the accessed data from the first optical state to the third optical state comprises driving the second portion of the bi-stable display (310) according to the accessed data such that the second voltage waveform is set to terminate before the first voltage waveform by the time difference (t2) of at least one frame period (FT).

27. The electronic reading device of claim 23, wherein:
the second optical state is substantially the same as the first optical state.

28. The electronic reading device of claim 23, wherein:
the control determines the time difference (t2) based on an ambient temperature (T).

29. The electronic reading device of claim 23, wherein:
the bi-stable display comprises an electrophoretic display.
